(19) United States
(12) Patent Application Publication
(10) Pub. No.: US 2011/0055367 A1
(43) Pub. Date: Mar. 3, 2011

(54) SERIAL PORT FORWARDING OVER SECURE SHELL FOR SECURE REMOTE MANAGEMENT OF NETWORKED DEVICES

(76) Inventor: James E. Dollar, Austin, TX (US)

(21) Appl. No.: 12/869,508

(22) Filed: Aug. 26, 2010

Related U.S. Application Data
(60) Provisional application No. 61/237,765, filed on Aug. 28, 2009.

(51) Int. Cl. G06F 15/173

(52) U.S. Cl. 709/223

(57) ABSTRACT

A system and method for the management of one or more wide area or local area network connected devices by a collocated managing device. The managing device uses serial port forwarding over a secure connection, such as a secure shell connection, to allow a centrally located administrative user to control the managed device.

### RELATED APPLICATION

This application claims the benefit of U.S. Provisional Application No. 61/237,765, filed on Aug. 28, 2009. The entire teachings of the above application are incorporated herein by reference.

### BACKGROUND OF THE INVENTION

The present disclosure relates generally to managing communications networks that include both local and remote devices, and more particularly to non-centralized secure management of the various devices and connections of these networks, using systems and methods both remote from and local to a centralized control location or facility.

The resources that implement communications networks, such as enterprise level networks, are conventionally managed from a central management location. The central management location may, for example, be the main office of an enterprise such as a company that has multiple geographically distant branch offices. Various software and hardware has been employed at the central location for the administration and support of the operation of these networks. To accomplish this, various database and network information, control, and other facilities are operated and accessed by network administrator personnel. These central management systems and facilities perform a wide variety of enterprise level functions, including, for example, device and network configuration, data retention and storage, database operations, control, enablement, authorization and permissions, and otherwise deal with the network as a whole.

Notwithstanding that these enterprise level network functions have typically been centrally administered and managed, various remote devices and localized network connections for these networks must also themselves be administered, managed, and otherwise supported wherever they are located. These localized network connections and devices include, for example, the Ethernet Local Area Networks (LANs) at each branch office. Administration, management and similar support for these localized network connections and devices often require dedicated facilities, systems, and personnel that are local to each separate branch location or network segment.

These centralized mechanisms rely on the use of the operational network to manage devices which are potentially responsible for the existence of a portion of that network. But automated “in-band” management techniques, using protocols such as Simple Network Management Protocol (SNMP), require the network itself to be functional. If components of the network fail, then the automated management infrastructure has no mechanism to provide a connection to the remote device, much less manage such a device. Mitigation for these shortfalls has included: using human resources collocated with the remote network and devices; using duplicative and additional network communications paths to provide alternate paths in the event of failures; using remote console server functions which make the local device console and command line interfaces available to a human resource at a location separate from a remote location. Additional administration, management and support of the devices and network connections at each remote locale can be required, as well. Communications infrastructure, personnel and facilities can be pricey, manpower intensive, and duplicative because of the remote support requirements of conventional enterprise systems.

### SUMMARY OF THE INVENTION

It would, therefore, be a new and significant improvement in the art and technology to provide systems and methods for non-centralized administration and management of communications networks that eliminate the need for certain personnel, equipment, and operational limitations inherent in centralized administration and management in conventional enterprise networks. The approach should permit aspects of remote and disparate network elements, such as branch office LANs, WANs, and devices, to be remotely controlled, addressed, managed and administered in as secure and seamless a manner as possible.

In one embodiment, the present invention is a system for securely and managing one or more communicatively connected devices of a remote local area network. The system includes a managing device, connected to a console connection (serial port) and, optionally, an Ethernet interface of one or more managed network device(s). The managing device is located in the same locale as the managed network devices. Data originating from the remote location is forwarded to a central administrative workstation only in a particular way over a secure connection, to ensure information security at the branch location.

In one aspect, the managing device may implement serial port forwarding over the secure connection to a virtual serial port on an administrative workstation. This permits a remote administrative user to securely operate element management software, despite only having a remote connection to the distant network device, in the exact same manner as if the administrative workstation were directly and physically connected to the managed device.

More particularly, in a first aspect of the invention, a Secure Remote Manager (SRM) appliance implements local processing of requests that may originate from a centrally located administrative user. These administrative users, typically located at a Network Operation Center (NOC) for the enterprise, access the SRM appliance via a Secure Shell (SSH) connection. The SSH connection, in a preferred embodiment, is carried over a Transmission Control Protocol over Internet Protocol (TCP/IP) network connection. The network management appliance can also forwards data from the remote location to the administrative user workstation via a Graphical User Interface (GUI), such as XWindows, over the SSH connection.

In a preferred embodiment of this implemention, the network connection from the SRM appliance to the administrative workstation is made over a dedicated physical layer connection, and is not a shared network connection. In this manner, maximum security can be provided.

Even with these communication architecture restrictions, the SRM appliance can continue to manage permissions, such as user authentication and log-in, completely within the secure enterprise environment. As a result, there is no need for elements at the NOC to implement AAA (authentication, authorization and accounting) or similar functions. For example, a Radius/TACACS server accessible to the SRM appliance can handle administrative user login and permission control completely within the secure environment of the remote location.

In one aspect, the SRM appliance can implement serial port forwarding to facilitate asynchronous communication between an administrative user's workstation at a central location and a serial port console connection of a managed device at a remote location. This is implemented in a way to appear as if the managed device were physically connected to a local serial port of the administrative workstation. This provides the ability to utilize element management software, generally provided by the managed device's manufacturer, executing on the administrative workstation to control the remotely managed device.

To utilize this functionality, the administrative user initiates a secure shell (SSH) connection to the SRM appliance and selects an option that requests a connection be made to a particular managed device using serial port forwarding. The administrative workstation then forwards a selected local serial port to a virtual TCP port available to it (i.e., “localhost” or “127.0.0.1”). On the administrative workstation, all asynchronous traffic from the virtual port is then configured to the forwarded port.

The SRM appliance local to the particular managed device at the remote location establishes a connection to a serial port of the requested managed device using a direct, physical, serial port connection dedicated to that device. The administrative user then issues a terminal forward command to the SRM appliance, which causes all interactive communication for the managed device to be forwarded, through the SRM appliance, to the element manager at the administrative workstation to control. As a result, all interactions occur via the SSH connection, through the SRM appliance, to the managed device's serial port.

Using the invention, the management of communications networks can dispose of certain economical, personnel, duplication, scale and operational limitations inherent in centralized administration and management in conventional enterprise networks.

The invention solves a problem with prior art approaches where end customers wish to protect their interface between the SRM appliance and the outside world as much as possible.

In addition, element management software can now be securely executed by a remote administrative user.

### BRIEF DESCRIPTION OF THE DRAWINGS

The present invention is illustrated by way of example and not limitation in the accompanying figures, in which like references indicate similar elements, and in which:

FIG. 1 illustrates a typical enterprise, including a first local area network (LAN) having a respective Secure Remote Manager (SRM) appliance connected to managed devices and connected to communicate with a remote administrative workstation;

FIG. 2 is an example element manager screen visible at the administrative workstation via serial port forwarding over Secure Shell (SSH);

FIG. 3 illustrates a system block diagram of the SRM appliance of FIG. 1, including a controller, element manager(s), local database, network interface, XWindows client, and serial port forwarding logic; and

FIG. 4 illustrates a method of operating of the SRM appliance, which includes determining operations to perform on the managed device, connecting to use the managed device, detecting the state of the managed device, transmitting commands to the managed device, receiving data from the managed device, parsing the received data, storing received data in a database, logging communications with the managed device, and reporting.

### DETAILED DESCRIPTION OF THE INVENTION

A description of example embodiments of the invention follows.

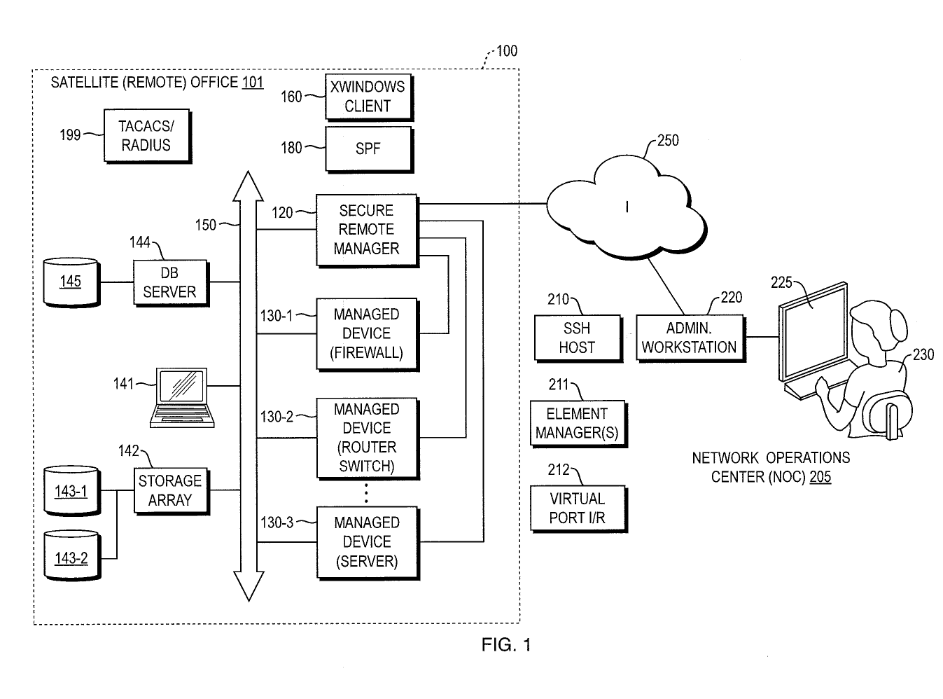

FIG. 1 illustrates an enterprise level data processing environment 100 where network devices at a remote location 101 are managed from a central Network Operations Center (NOC) 205. More particularly, a system 100 for autonomously managing co-located devices at a remote location 101 includes a first Secure Remote Manager (SRM) appliance 120. The SRM appliance 120 (also sometimes called the “managing device” herein) is connected to one or more managed devices 130 that may include, but are not limited to, a firewall 130-1, a router or switch 130-2, or server 130-3 (collectively referred to herein as the managed devices 130) that provide connectivity to allow other devices to access to a Local Area Network (LAN) 150.

The LAN 150 will typically also have other devices connected to it, such as end user devices such as personal computers 141, a storage array 142, or a database server 144, each of which connects to and interfaces with the LAN 150. The LAN 140 may in turn provide connectivity and other services to end user computers 141 that not shown in FIG. 1 such as a gateway to a wide area network (WAN) such as the Internet.

Although also not shown explicitly in FIG. 1, it should be understood that the enterprise data processing systems may typically also encompass other remote locations having a similar network structure(s) with an SRM appliance 120 located in each locale that there are managed devices 130.

The SRM appliance 120 provides local autonomous management of the managed devices 130. In a preferred embodiment, the SRM appliance 120 receives commands from and provides information to an administrative user 230 located at the NOC 205 via a Transmission Control Protocol/Internet Protocol (TCP/IP) connection over a network such as the Internet 250. In a preferred embodiment, data is passed using secure shell (SSH) over the TCP/IP connection and an XWindows client 160 that interfaces to an XWindows host 210 running on an administrative workstation 220.

The SRM 120, as will be understood and described more particularly below, does not pass enterprise application level data over this SSH connection to the administrative workstation 220. In particular, all such data remains local to the satellite location 101, and the administrative user 230 is granted no access to the same by the SRM appliance 120. For example, data stored in storage array 142 or database 144 is not accessible to the administrative user 230. The only interface by administrative user 230 to the LAN 150 is through the SRM appliance 120 and XWindows host 210 and XWindows client 160.

As it is known in the art, the XWindows server or host 210 is a software process that runs on the administrative user's workstation 220 to provide a networked graphical user interface. The XWindows client 160 is a helper application that runs on the SRM appliance and sends commands to the XWindows host 210 to open windows on the workstation 220 and render bitmaps or other graphical information in those windows.

SSH allows the connection between the XWindows client 160 and XWindows host 210 to be secure and authenticated. SSH can, for example, support a wide variety of encryption algorithms including AES-256 and 3DES. It supports various other algorithms and can use public key cryptography or traditional user name/passwords for authentication.

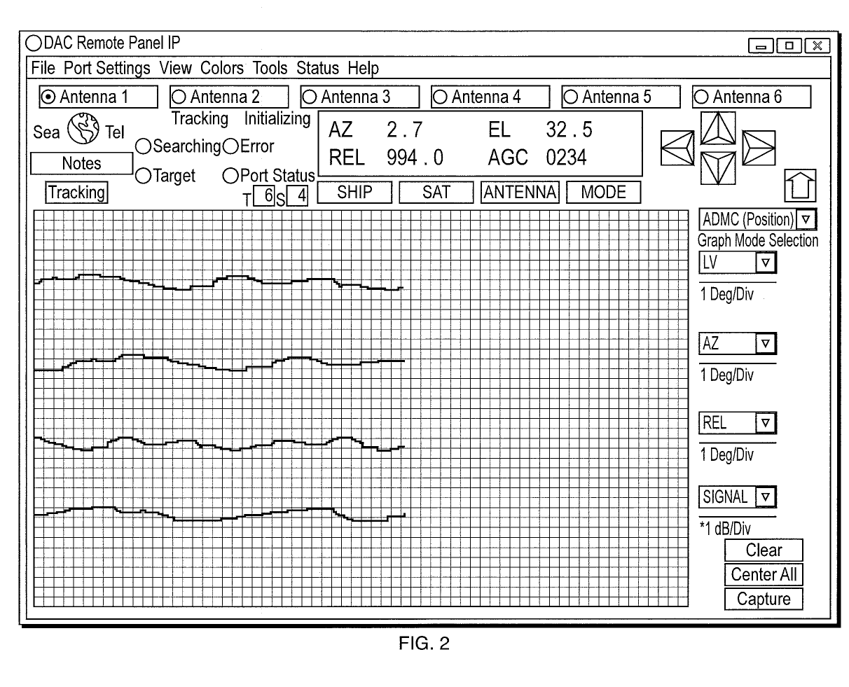

FIG. 2 illustrates an example of a screen that might be shown on the workstation 220 to the administrative user 230. In accordance with aspects of the present invention which will be explained more fully below, this screen is rendered by an element manager running on the administrative workstation 220. In the non-limiting example shown, the managed device 130 can be a satellite communication antenna such as the SeaTel 2202 available from SeaTel, Inc. of Concord, Calif. The particular element manager 211 in this example, called the “DAC Remote Panel” (also available from Sea Tel), is designed to connect to the antenna 130 over a serial port that is local to the antenna 130. However, via the use of the SRM appliance 120, this serial connection is forwarded to the administrative workstation 220, using serial port forwarding over SSH.

The SRM appliance 120 performs numerous functions in connection with controlling the managed devices 130. Referring back to FIG. 1, the SRM appliance 120 manages the managed devices 130 by connecting to them via a device console interface connection such as via a serial port (RS-232) interface. Each managed device 130, be it a router, firewall, switch, server or other type of managed device (such as the satellite communication antenna) 130 supports a corresponding console connection and can be managed by the SRM appliance 120 independent of the connections to any devices or networks such their respective Ethernet interfaces to the LAN 150. As will be described below, serial port forwarding is used to allow the administrative workstation 220 to control the managed device 130, such as via an element manager 211 running on the administrative workstation 220, despite the fact that the administrative workstation 220 is located at the NOC 205 but the managed devices 130 are located at a remote site 101.

A “console connection”, as used herein, may include a serial port that provides visibility to intercept input/output commands made to and received from the managed device such as may be a keyboard/screen interface, command line interface (where commands are intended to entered as sequences of typed characters from a keyboard, and output is also received as text) or similar interface.

The SRM appliance 120 can additionally connect to the LAN 140 directly to communicate with any other LAN—connected devices (e.g., 130, 141, 142, 144, etc.) and networks. The SRM appliance 120 can construct and communicate synthetic transactions to simulate normal network transactions and thereby measure various network based services, their performance and availability. However, the preferred management connection between SRM appliance 120 and the managed devices 130 is via an individual dedicated serial port console connection to each managed device 130.

Secure Shell Version 2 is the default method of communicating between an SRM appliance 120 and the NOC 205. Remote administrative users 230 may authenticate using passwords, certificates or a combination of both. The SRM appliance 120 has recognized both DSA and RSA encryption methods with key lengths, for example up to 2048 bytes. SRM appliances 120 facilitate communication between managed devices connected to the appliance, for example a Cisco router via the serial connection and an RSA authentication manager. The SRM appliance 120 reads the current authentication code from an attached RSA secure ID device and passes it on to the managed device. The managed device 130 can then use the credentials with the RSA authentication manager to enforce two factor authentication.

User authentication for SRM appliances 120 can be directed to a Radius or a TACACS server 199, keeping user passwords synchronized throughout the enterprise while authorization is maintained on the appliance itself. The SRM appliance 120 can optionally cache TACACS ACL passwords locally in case authentication server cannot be reached. Some TACACS accounting features can be supported by the SRM appliance 120. Accounting events can be sent to a configured TACACS server using a start stop (before and after each command), or a stop only (after each command) model.

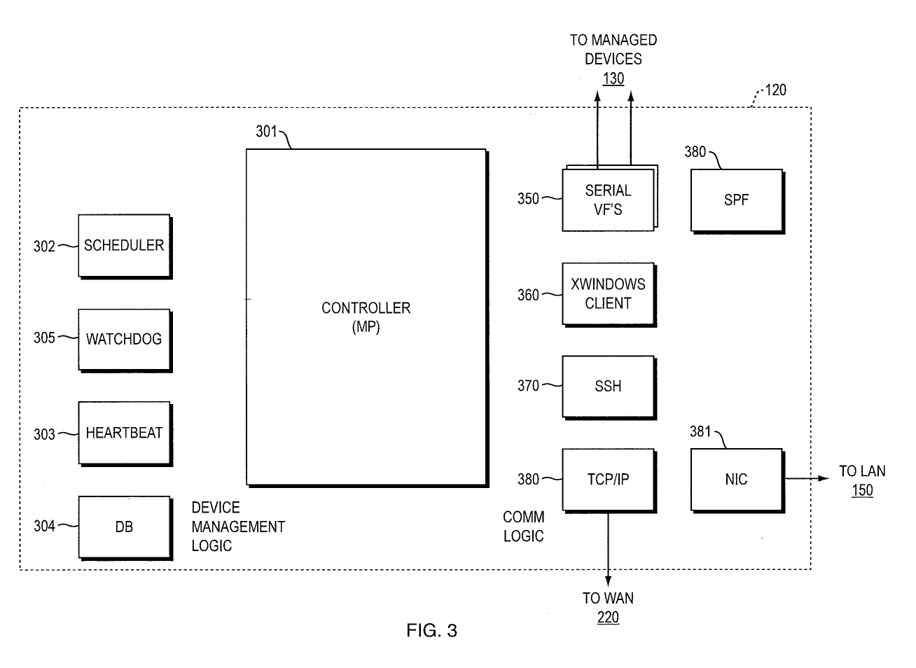

FIG. 3 illustrates the SRM appliance 120 of FIG. 1 in more detail, including a main controller microprocessor 301 that has program logic to perform autonomous device management functions, and communications logic to send and receive data and commands to and from external devices including the managed devices 130, the administrative workstation 220, and to other devices local to the same LAN.

The autonomous management functions of the SRM appliance 120 include communicating with one or more of the managed devices 130, acting as an intermediary or proxy, to perform serial port forwarding to and from the administrative workstation 220 translating requested operations from external devices such as the administrative workstation 220 into a managed device specific set of command interactions, monitoring the status of managed device 130, detecting the failure of managed device 130 function, analyzing and storing data derived from the monitoring data from managed devices 130 and, heuristically determining when to establish the point to point alternate communication paths.

The autonomous functions of the controller 301 enable management of the managed devices 130 and the local area network connection 140, including its devices and elements, either independently of or in concert with management resources available over the WAN 250 but remote from the general locale of the managed devices 130. The controller 301 can also autonomously create synthetic transactions to send to another device on the connected network 140, the device being managed or unmanaged, to simulate normal network transactions and thereby measure various network based services, their performance and availability. These synthetic transactions can also be used to detect the failure of network segments and services.

More particularly, SRM appliance 120 includes various communication interfaces. A first class of such interfaces includes one or more serial interfaces 350, for example, RS-232 interfaces, that connect to the serial ports of the managed devices 130. As mentioned previously, there is preferably a dedicated serial interface 350 for each managed device 130.

A second type of interface is a Network Interface (NIC) 381 that provides connections to the LAN 150, such as an Ethernet interface.

A third type of interface is to the WAN 250 to provide connectivity to the administrative workstation 220 at the central location. This interface made be shared with the Ethernet interface or may be a dedicated (dial up or leased line) connection between the satellite or remote office 101 locale of the SRM appliance 120 and the NOC 205. This interface includes a standard communication protocol stack including at least TCP/IP 380. An SSH stack 370 and XWindows client 360 allows the controller 301 to securely receive commands from and send information to the administrative workstation 220 as explained above.

In one embodiment of the invention, a serial port forwarding (SPF) function 380 is also used to facilitate asynchronous communication between administrative workstation 220 and the managed devices 130. This provides the ability for the SRM appliance 120 to forward serial port commands and messages to and from the managed devices 130 and workstation 220 generally under instruction from an administrative user 230 running element manager software. Element management software is provided by the manufacturers of the managed devices 130 to manage their operation. Using the SPF function 380 and virtual port functions at the administrative workstation 220, the element manager can run on the workstation 220, since the SPF 380 makes it appear as if the administrative user's workstation 220 located at the NOC 205 were directly connected to a managed device 130 at the remote location 101.

To utilize the serial port forwarding 380 functionality, the administrative user 230 (within the context of the XWindows GUI) initiates a secure shell connection to the SRM appliance 120. She then navigates to an appropriate interface that manages the port for the managed device 130. The user 230 then requests a serial port be forwarded to a TCP port available to her local workstation (such as “local host” or 127.0.0.1). On the administrative workstation 220, a serial port forward software application then configures all asynchronous traffic from a virtual communication port (virtual COM port) to the forwarded port and presents itself to the administrative workstation 220 as an available physical COM port (i.e., COM3). This serial port forwarding function may be based on RFC2217, but uses Secure Shell (SSH) to pass commands and data to the administrative workstation 220

The user 230 then issues a terminal forward command on the SRM appliance 120, causing forwarding all interactive communication for the selected managed device 130 to be forwarded the administrative workstations “COM3” port for the element manager 306 to control. The user finally launches the element manager 211 application software on her workstation 220, which connects to the virtual “COM3” port; all interactions continue to occur via the SSH connection through the SRM appliance 120 to the managed device 130.

It should be understood that all of these operations to set up serial port forwarding can also be handled automatically, in a software process, instead of requiring user interaction for certain steps, or any combination of user initiated and automated steps.

The SRM appliance 120 can also include other functions such as a database 304. The database 304 comprises a wide variety of information including configuration information, software images, software version information, user authentication and authorization information, logging information, data collected from connected devices, and data collected from various monitoring functions of the controller 301, and is capable of performing various database operations. The database 304 performs many of the same operations and has many of the same features as a typical network administration database of a centralized network administrator (including software, hardware, and/or human administration pieces); However, the database 304 is included in the SRM appliance 120 itself and provides the administration functions locally at the LAN 150 where the SRM appliance 120 is located.

For example, the database 304 can store and manipulate configuration data for devices and elements connected to the SRM appliance 120, such as devices and elements of the LAN 150, as well as configuration information for the SRM appliance 120.

Moreover, the database 304 of the SRM appliance 120 includes log data. The log data includes audit information from communication sessions with managed devices 130, state and update information regarding the elements and devices connected to the SRM appliance 120. The logging information in database 304 may also include user interaction data as captured via autonomous detection of data entered by an administrative user 230 via the console connection or other connections.

The database 304 also includes software images and version information to permit upgrade or rollback the operating systems of managed devices 130. The database 304 also includes data on users, groups, roles, and permissions which determine which users can access which functions and resources through SRM appliance 120 as well as the functions and resources of SRM appliance 120 itself.

The database 304 also includes rules and threshold values to compare to other state information stored by the controller 301 which the controller 301 uses to determine if it should initiate communication with any connected devices on LAN 150 or remote external devices 161 through the communications with WAN.

The database 304 also typically includes other data as applicable to the environment and usage of the SRM appliance 120 in administering the LAN 312 in concert with other similar implementations of the SRM appliance 120 in other remote locations and with other LANs of the enterprise.

The controller 301 is connected to a scheduler 302 of the SRM appliance 120. The scheduler 302 provides timing and situational triggering of operations of the SRM appliance 120 as to each particular element and managed device 130 and also as to external sources available for local administration via the LAN 150. For example, the scheduler 302 periodically, at time intervals dictated by configuration information from database 304 of the SRM appliance 120, causes the controller 301 to check a state of the LAN 150 or a device 130 or element thereof. Additionally, for example, the scheduler 302, upon detecting or recognizing a particular occurrence at the LAN 150 or its devices or elements, can invoke communications by the SRM appliance 120 externally over the WAN in order to obtain administration data from external devices to the LAN 150 and SRM appliance 120, such as from a centralized or other external database or data warehouse.

The watchdog 305 function of the SRM appliance 120 monitors the controller 301 to determine if the controller 301 is still operationally functioning. If the watchdog function determines that the controller is no longer operational, the watchdog 305 will cause the controller 301 to restart.

The controller 301 can also be connected to a heartbeat function 303 which, on a schedule determined by the scheduler 302, attempts to communicate to remote external devices via the LAN 150 connection to WAN 250. Should the communication path via LAN 150 not respond, then the controller will initiate the establishment of an alternate point to point communication path to WAN 250.

The foregoing examples are intended only for explanation of the localized autonomous management functions of the SRM appliance 120, and are not intended and should not be construed as limiting or exclusionary. In practice, the SRM appliance 120 described herein performs most, if not all, of the administration operations for an enterprise network, albeit only at the local network or LAN level, either independent of or in synchrony and cooperation with the overall enterprise network (which can comprise multiple ones of the SRM appliances 120 for multiple LANs ultimately included within the aggregated network enterprise). The SRM appliance 120 so administers the LAN (rather than a centralized administration for an entire enterprise WAN). Moreover, as hereinafter further described, each SRM appliance 120 can, itself, be accessed remotely, for at least certain administration operations for the LAN made remote from the LAN.

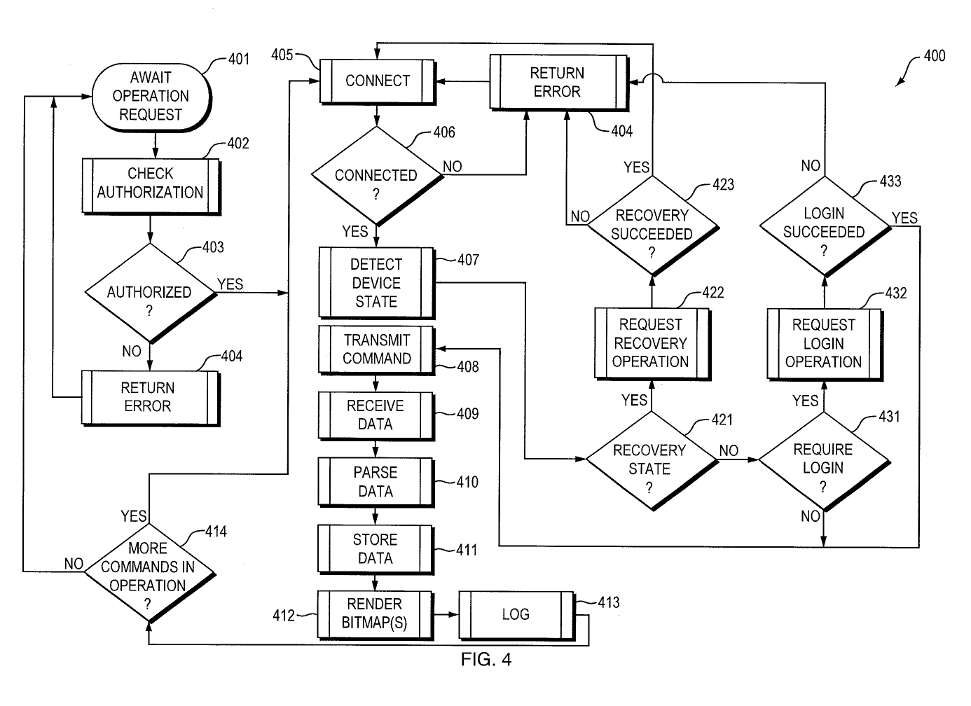

FIG. 4 illustrates a method 400 of performing autonomous operations of the SRM appliance (managing device) 120. A request to perform an operation can come from an autonomous controller 301 process, by an administrative user 230 running the element manager 211 on their workstation 220, or by direct user command to the SRM appliance originating at the remote site 101.

The operations include a step of determining the authorization 402 of the requesting agent to perform the requested operation. The request information is compared to authorization in the local database 304, or alternatively sent to an authorization function communicatively connected to the managing device 120 but located outside of the managing device 120 (such as a TACACS, Radius, LDAP, or other certificate authority).

The method then determines whether the operation request is authorized in step 403. If it is not, then a step 404 returns an error to the requestor. If the request is authorized, then in the next step 405 a connect is performed.

In the step of connecting 405, the managing device 120 is physically connected such as via a direct serial communication to the managed device 130 (shown in FIGS. 1-3), and seeks to communicably connect with a managed device 130. If the step of connecting 405 does not communicably connect within a certain time period as determined from the database 304, then an error 404 is returned to the requestor. However, if the managing device 120 successfully connects with the managed device of step 405, then the method 400 proceeds to a step 407 of managed device state checking.

In a state checking step 407, various operations are performed by the managing device, 120 in communication with the managed device, to determine a current state of the managed device. The device state check step 407 includes a step 421 of determining whether the managed device 130 in a “recovery” state. A “recovery” state is any state in which the managed device is not ready to accept a command. If the managed device is in a “recovery” state, then the next step recovery operation 422 is performed. The recovery operation attempts to communicate with the managed device to cause it to reset itself, restore itself by rebooting an operating system image when a low level boot state indicates that an operating system image is bad, or to cause a connected power controller 317 to turn off and turn on the managed device 130. In step 423, the method determines if the device recovery was successful. If the recovery was not successful, then an error 404 is returned to the requestor. If the recovery was successful, the next step is to return to connect 405 in an attempt to again perform the original operation requested in 401.

If the managed device 130 is in a state to receive commands, then method determines if the managed device 130 is ready to receive commands other than the login commands 431. If the managed device 130 is not ready to receive commands other than login, then the next step request login operation 432 is performed. The request login operation 432 sends the necessary authentication commands to the managed device in an attempt to place the device into a “logged-in” state. If the request login operation 432 does not succeed in placing the managed device 130 in a “logged-in” state, then an error is returned to the requestor.

If the managed device is in a “logged-in” state, then the managed device 130 is ready to receive functional commands, and the next step 408 a transmit command is performed. Each requested operation may consist of one or more commands that are sent to the managed device 130, as well as one or more recognized response patterns. The transmit command function 408 determines the correct command to send to the managed device 130 based upon the device state, and send that command string. In one preferred embodiment, the commands are sent and received via a console communication interface (console port) and serial port forwarding over SSH, as mentioned previously.

The next step of the method 400 is to receive data in step 409. The receive data step 409 collects the byte stream of data received from the managed device for a period of time specific to the managed device. The receive data step 409 attempts to determine whether the managed device 130 has completed sending a stream of data in response to the transmit command step 408. If the receive data step 409 either determines that the received data stream is complete, or if the period of time allotted to this step passes, then the receive data function is complete.

The next step of the operation 400 is to parse data 410. The parse data step 410 attempts to transform the byte stream received in the receive data step 409 into a form suitable for storage in a database.

The transformed data from parse data step 410 is then stored in a database in step 411. The next step is to store the audit data from the command interaction with the managed device 130 in the log session, step 413. The audit data is stored in a secured data store for later retrieval by audit functions.

At or after this point, in step 412, bitmaps or other graphic indication of successful operation of a command are rendered or updated to the user 230, such as via the element manager 211.

The next step 414 in the overall process 400 is to determine whether there are additional commands that must be sent to the managed device 130 to complete the requested operation (back in step 401). If there are additional commands to be sent to the managed device 130, the next action is to return to the connect function step. If there are not additional commands to be sent to the managed device 130, then the operation 400 is complete.

In preferred embodiments, the managing device (SRM appliance) 120 delivers remote management and control by interfacing directly through the console port of the devices they manage. This connection enables secure, always on, around the clock management for remote IT infrastructure. The SRM appliance 120 can automate the majority of routine IT support functions, such as monitoring, configuration, fault and service level management, and autonomously address the majority of issues that can cause network related outages, including configuration errors, wedged or hung devices, and telecom faults.

With a web-based graphical user interface (GUI), the approach of the preferred embodiment puts an IT administrator in control of real time data to easily manage, configure and control all network devices and servers connected to SRM appliances. Deployed at the network operations center, administrative user can now perform real time monitoring and management through a unified view of what is occurring in the distributed infrastructure.

By using the SRM appliance 120 as a gateway to manage remote devices, IT policies can be enforced, whether working in band or out of band. User authentication can be directed to an existing Radius or TACACS server, in order to keep user passwords synchronized throughout the enterprise while authorization is maintained on the SRM appliance 120. User sessions can be controlled to avoid unauthorized access to systems, and authorization controls can be centrally defined and managed to enforce who has access to which systems.

In addition, the SRM appliance 120 can capture all changes made to systems and the results of those changes all of the time to enable complete compliance reporting. For example, the SRM appliances 120 can be configured to record every user's keystroke and output, unlike accounting tools, i.e., TACACS or configuration management solutions that can fail to capture changes during a network outage. Complete log data, including session, syslog and console data can be forwarded to compliance management systems for analysis and customized compliance reporting.

When a network is functioning properly, the SRM appliance 120 can use an Ethernet-based connection to connect to the centralized management server, control center at the network operations center. But when it is not, it can dial out and immediately establish connectivity via a secure out of band path using a variety of backup network communications, including a dial up modem, cellular network or satellite communication. This ensures secure always on access and connectivity to the remote devices and media management.

This management operation of the managing device 120 is performed by the managing device specifically and particularly as to the each connected managed device. Moreover, the managing device 120 performs this management operation at the LAN and without any external support or administration (unless the managing device then-determines that such external support or administration is appropriate or desired). Thus, the managing device, located at and operational with respect to the particular LAN and its devices and elements, is not dependent on centralized administration, and administers the network piece comprised of the LAN and its elements and devices in non-centralized manner from other LANs, elements, devices, and any WAN. Of course, as has been mentioned, centralized or remote from the LAN accessibility can still be possible with the managing device, and, in fact, the managing device can logically in certain instances make assessments and control and administer with external resources. However, the managing device 120 eliminates the requirement that each and every administration operation be handled by a centralized administrator as has been conventional, and instead locally at the LAN administers the LAN in concert with other LANs of an aggregate enterprise network also each administered by a respective managing device in similar manner.

The foregoing managing device, and the systems and methods therefore, provide a number of operational possibilities 120. In effect, the typical Network Operations Center (NOC) 205 in a centralized network administration arrangement is not required to administer the network via the managing device(s). Each individual managing device can administer a number of similarly located devices of a network, and multiple ones of the managing device(s) 120 can be supplied to accommodate greater numbers of devices in the same or other locations. A local area network (or even one or more networked devices) that is located at a location remote from other network elements is administered via the managing device when thereat connected. This arrangement of the administrating managing device 120 for addressing administration of each several network devices, where the managing device 120 is located at the location of the several devices (rather than at a specific centralized location), enables a number of unique operations and possibilities via the managing device.

One unique operation for the managing device 120 is the localized management of local devices of a LAN, at the location of the devices and not at any remote or other centralized administration location. Certain localized management operations of the managing device 120 as to the connected local network devices include rollback of device configurations and settings in the event of inappropriate configuration changes, continuous monitoring of device configuration and performance, automated maintenance of devices, and security and compliance via secure connectivity (SSHv2), local or remote authentication, complete audit tracking of device interactions, and granular authorization models to control remote device access and management functions. All of these operations are possible because of the logical and functional operations of the managing device 120, and the particular system design and arrangement of the managing device, at the locale of networked devices connected to the managing device.

Moreover, the managing device 120 provides nonstop management of connected network devices via the re-routing of management activity over the back-up or ancillary external network (or WAN) connection. As mentioned, in case the primary external network access is unavailable or interrupted at the managing device 120, the modem of the managing 120 device provides an ancillary dial-up or similar path for external access. In operation, the managing device automatically re-routes management communications to the ancillary access path rather than the primary network access path upon occurrence of device, network, or power outages, as the case may be and according to the desired arrangement and configuration of the managing device. Additionally, the local autonomous management functions of the managing device 120 are unaffected by the unavailability of the primary data network, since the managing device can use the console communications path to communicate with the managed device 120.

Other operations of the managing device 120 when connected to devices include, automatic, manual, or directed distributed configuration management for the devices connected to the managing device. For example, in an enterprise network having a centralized administrator and database, the managing device, as it manages devices 130 remote from the centralized location, communicates configuration and setting information for devices and the remote localized network to the centralized administrator and database for an enterprise network. In such an arrangement, the managing device provides primary administration for the connected devices and network, and the centralized administrator and database can continue to administer the enterprise generally, such as where the managing device does not/can not handle management or where back-up or centralization of administration operations are nonetheless desired.

Another operation of the managing device 120 provides dynamic assembly of drivers for connected devices 130 or 140 and networks to the managing device 120. For example, the managing device 120, automatically or otherwise, logically discerns connected devices and drivers appropriate for such devices, including updates and the like, as well as for initialization on first connection. This limits error or problems in set-up and configuration at the connected devices and network and manages such items at any remote locations. The database and logical operations of the managing device 120, at the locale, dynamically assemble drivers for multitudes of devices and localized network implementations, in accordance with design and arrangement of the managing device 120.

The managing device 120 additionally enables various applications to be run and performed at the locale of the connected devices and localized network. These applications include a wide variety of possibilities, such as, for example, data collection with respect to devices, usage and performance, e-bonding, QoE, decision-making for management of the local devices and network, and the like. Of course, the possibilities for such applications is virtually limitless with the concept of localized administration and application service via the managing device 120 for the connected devices 130, 140 and network elements.

A wide variety and many alternatives are possible in the use, design, and operation of the managing device 120, and the LANs, devices, elements, and other administered matters described in connection therewith.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention.

Benefits, other advantages, and solutions to problems have been described above with regard to specific embodiments. However, the benefits, advantages, solutions to problems and any element(s) that may cause any benefit, advantage, or solution to occur or become more pronounced are not to be construed as a critical, required, or essential feature or element of any or all the claims. As used herein, the terms “comprises, “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. An apparatus for autonomously managing one or more collocated managed devices, comprising:
a secure remote manager (SRM) device, connected to at least one of said one or more managed devices, the SRM device located in the same network locale as the managed devices;
said SRM device further comprising;
a serial port communication connection to at least one of the managed devices;
a controller embedded in the SRM device; and
wherein said controller uses serial port forwarding over a secure connection to provide connectivity between the managed devices and an administrative user workstation.

2. The apparatus of claim 1 wherein the secure connection is provided using Secure Shell (SSH).

3. The apparatus of claim 1 wherein a virtual serial port is used to connect the administrative workstation to the managed device through the secure remote manager.

4. The apparatus of claim 1 wherein element manager processing executes in the central administrative workstation.

5. The apparatus of claim 1 wherein database data concerning end user information is not accessible at the administrative workstations.

6. The apparatus of claim 1 wherein the SRM device further manages administrative user authentication and login.

7. The apparatus of claim 1 wherein the connection from the SRM device to the administrative workstation is not shared.

8. A method for managing one or more collocated managed devices, the method comprising:
establishing a console communication connection to at least one managed device to be managed, the console communication connection respective to each of the managed devices and independent of all other connections to managed devices; and
forwarding the console communication connection to a centrally located administrative workstation over a secure wide area network connection, the wide area network connection established using serial port forwarding over a secure shell networking protocol.

9. The method according to claim 8 additionally comprising:
forwarding one or more operations to one or more of the managed devices, as received from the administrative workstation, to manage the one or more collocated managed devices.

10. The method according to claim 8 further comprising
storing information regarding a managing device or the managed devices, the information not accessible to the managed devices or the administrative workstation.

11. The method according to claim 8 further comprising:
communicating with the managed device via a command line interpreter over the forwarded serial connection.

12. The method according to claim 8 further comprising:
obtaining an operation to be processed for one of the managed devices;
authorizing the operation;
connecting to the managed device via the console communication connection forwarded via serial port forwarding over a secure shell connection, to provide a forwarded console communication connection;
detecting a state of the managed device via the forwarded console communication connection;
transmitting the operation to the managed device via the forwarded console communication connection; and
receiving data indicative of execution of the operation from the managed device via the forwarded console communication connection.

13. The method according to claim 12 and further comprising:
parsing the operation's results; and
storing the operation's results.

14. The method according to claim 8 and further wherein the forwarded console connection is provided to an element manager executing on an administrative workstation.

15. The method according to claim 14 wherein the administrative workstation is located at a central enterprise location, and the managing device and managed devices are located at a remote location.
